(19) United States
(12) Patent Application Publication
(10) Pub. No.: US 2025/0130148 A1
(43) Pub. Date: Apr. 24, 2025

(54) AN EXPERIMENTAL DEVICE FOR LONG-TERM LOADING AND SYNCHRONIZED MEASUREMENT OF THE CONCRETE-ENCASED CONCRETE-FILLED STEEL TUBE STRUCTURE

(71) Applicants: GUANGXI UNIVERSITY, Nanning, Guangxi (CN); DALIAN UNIVERSITY OF TECHNOLOGY, Dalian, Liaoning (CN); BEIHANG UNIVERSITY, Beijing (CN)

(72) Inventors: Yonghui AN, Dalian, Liaoning (CN); Songlin LI, Dalian, Liaoning (CN); Danyang MA, Dalian, Liaoning (CN); Jinxiang ZHONG, Dalian, Liaoning (CN)

(21) Appl. No.: 18/280,090

(22) PCT Filed: Jul. 3, 2023
(86) PCT No.: PCT/CN2023/105505

§ 371 Date: Dec. 24, 2024

(51) Int. Cl. G01N 3/08; G01N 3/06

(52) U.S. Cl. CPC G01N 3/08; G01N 3/066

(57) ABSTRACT

The present invention provides an experimental device for the long-term loading and simultaneous measurement of a concrete-encased concrete-filled steel tube structure. The device comprises a loading component, a load measurement component, a deformation measurement component, and the concrete-encased concrete-filled steel tube structure. The loading component mainly consists of loading plates, loading rods, nuts, and pre-tightened disc springs. The load measurement component comprises force sensors. The deformation measurement component mainly consists of measurement devices. The concrete-encased concrete-filled steel tube structure serve as the load-bearing structure. By inventing the experimental device for the long-term loading and simultaneous measurement of the concrete-encased concrete-filled steel tube structure, it achieves phased loading and simultaneous measurement of internal forces and deformations of the embedded concrete filled steel tube and the external reinforced concrete. It provides reliable experimental results for further studying the redistribution of internal forces and development of deformations of such structures under long-term loading.

### TECHNICAL FIELD

The present invention belongs to the field of structural engineering technology, specifically involving an experimental device for long-term loading and synchronized measurement of the concrete-encased concrete-filled steel tube (CECFST) structure.

### BACKGROUND

As a new type of engineering structure, CECFST structure has multiple advantages, including high load-bearing capacity, good seismic performance, structural stability, and excellent corrosion resistance. Therefore, it is widely used in bridge construction projects. However, under long-term loading, concrete exhibits significant creep effects due to its inherent material properties. In the case of long-span arch bridges, concrete creep can result in internal force redistribution, which will have a nonlinear effect on the force of the structure and seriously affect the force and deformation of the structure, that it will bring security risks to the engineering project.

Regarding the CECFST structure, the currently used load measurement devices, such as the loading device described by Wang Qingli et al. in “The Device and Method for Studying the Performance of Concrete-filled Steel Tube Axial Compression Members under Load and Corrosion,” often only allow for one-time loading of the entire cross-section of the CECFST structure. They can not achieve phased loading of the core concrete-filled steel tube (CFST) and the external reinforced concrete (RC) portions of the structure. As a result, the study of the mechanical performance of this structure under phased construction conditions is limited.

The invention provides a testing device for long-term loading and synchronized measurement of CECFST structures. With this testing device, phased loading of the embedded CFST and the external RC can be achieved. It enables long-term synchronized measurement of internal forces and deformations of each component of the structure. The invention solves the problem of existing loading devices being unable to accurately differentiate the internal forces and deformations of the CFST and the external RC under phased construction conditions. It provides technical support for further research on the redistribution of internal forces and the development of deformations of such structures under long-term loading.

### SUMMARY OF THE INVENTION

The invention proposes a testing device for long-term loading and synchronized measurement of CECFST structures. Conventional loading devices often treat the CECFST structure as a whole, without considering the phased construction and load-bearing characteristics of such structures, and the embedded CFST and the entire structure are rarely loaded and measured in stages. The invention aims to address the issues in existing loading and measurement techniques for CECFST structures. It proposes a two-stage loading approach, where the embedded CFST portion and the entire structure are loaded separately. The force conditions of the embedded CFST portion and the external RC portion are measured independently, allowing for individual force analysis and determining the creep behavior of each concrete component. This provides a basis for accurate scientific calculations and analysis in practical engineering applications.

The technical scheme of the invention is as follows:

The invention relates to a testing device for long-term loading and synchronized measurement of CECFST structures. The device comprises a loading component 10, a load measurement component 20, a deformation measurement component 30, and a CECFST structure 40.

The loading component 10 comprises an upper loading plate 101, a lower loading plate 102, a spoke sensor pad 103, a spoke sensor nesting plate 104, a lower loading rod 105, an upper loading rod 106, lower nuts 107, middle nuts 108, upper nuts 109, lower disc springs 110, middle disc springs 111, and upper disc springs 112. The upper loading rod 106 passes through the upper loading plate 101, and its end is fixed on the upper loading plate 101 by the upper nuts 109 and the upper disc springs 112. The lower loading rod 105 passes through the spoke sensor nesting plate 104 and the lower loading plate 102, and its end is fixed on the lower loading plate 102 by the lower nut 107 and the lower disc spring 110, and its lower portion is fixed on the spoke sensor nesting plate 104 by the middle nut 108 and the middle disc spring 111. The spoke sensor nesting plate 104 has a central hole, and one end of the spoke sensor pad 103 extends into the central hole of the spoke sensor nesting plate 104. There is a certain gap between the inner wall of the central hole of the spoke sensor nesting plate 104 and the outer wall of the spoke sensor pad 103, and the end of the spoke sensor nesting plate 104 is in the same plane as the surface of the spoke sensor pad 103. The other end of the spoke sensor pad 103 is located on the lower loading plate 102.

At least four upper loading rods 106, four lower loading rods 105, four upper nuts 109, four lower nuts 107, four upper disc springs 112, and four lower disc springs 110, together with the upper loading plate 101, the spoke sensor pad 103, and the lower loading plate 102, form the loading structure for the internal CFST of the CECFST structure 40. At least four upper loading rods 106, four lower loading rods 105, four upper nuts 109, four middle nuts 108, four upper disc springs 112, and four middle disc springs 111, together with the upper loading plate 101 and the spoke sensor nesting plate 104, form the loading structure for the outer RC of the CECFST structure 40. Among them, the upper loading rod 106, the lower loading rod 105, the upper nut 109, the upper disc spring 112, and the upper loading plate 101 are common parts shared by the loading structure of the internal CFST of the CECFST structure 40.

The load measurement component 20 includes tension sensors 21 and a spoke sensor 22. The tension sensor 21 is connected to the lower loading rod 105 and the upper loading rod 106 at both ends and is used to measure the load of the CECFST structure 40. The spoke sensor 22 is installed on the spoke sensor pad 103 and is used to measure the load of the CFST.

The deformation measurement component 30 includes displacement gauges 31, lower supports for displacement gauges 32, upper supports for displacement gauges 33, wire ropes 34, and multiple strain gauges. At least two displacement gauges 31 and five strain gauges are combined to form the deformation measurement system of the CECFST structure 40. The displacement gauges 31 are connected between the upper loading plate 101 and the spoke sensor nesting plate 104 through the upper supports for displacement gauges 33 and the lower supports for displacement gauges 32. The strain gauges are bonded to the internal and surface of the CECFST structure 40.

The CECFST structure 40 consists of a steel tube 41, concrete inside the steel tube 42, concrete outside the steel tube 43, longitudinal bars 44, and stirrups 45. It serves as the loading and measurement object of the experimental device and is geometrically aligned within the structural framework of the loading component 10. The steel tube 41 and concrete inside the steel tube 42 form the CFST, while the concrete outside the steel tube 43, longitudinal bars 44, and stirrups 45 form the outer RC.

Furthermore, the cross-section of the spoke sensor pad 103 is the same shape and has an equal area as the cross-section of the CFST.

Furthermore, the spoke sensor pad 103 is equipped with threaded columns and is connected to the threaded hole of the spoke sensor 22 in the load measurement component 20.

Furthermore, the height of the spoke sensor pad 103 is adjusted by lower nuts 107 and the lower loading plate 102, ensuring that the spoke sensor nesting plate 104 and the spoke sensor pad 103 remain in the same plane throughout the entire loading process.

Furthermore, during the pouring of the CECFST structure 40, there are no restrictions on the shape of the cross-section of the steel tube 41 and the concrete outside the steel tube 43.

Furthermore, the strain gauges include concrete longitudinal strain gauges 35, steel tube transverse strain gauges 36, steel tube longitudinal strain gauges 37, longitudinal bar strain gauges 38, and stirrup strain gauges 39.

The installation method for a test device that enables long-term loading and synchronous measurement of a CECFST structure is described. The specific steps are as follows:

Step 1: As shown in FIG. 5-\textcircled{1}, weld the steel tube 41 at the geometric center position of the upper loading plate 101.

Step 2: As shown in FIG. 5-\textcircled{1}, pour the concrete inside the steel tube 42 from the other end of the steel tube 41.

Step 3: As shown in FIG. 5-\textcircled{3}, install four sets of upper disk springs 112, upper nuts 109, and upper loading rods 106 successively at the corresponding holes of the four corners of the upper loading plate 101.

Step 4: As shown in FIG. 5-\textcircled{4}, connect one end of the tension sensor 21 to the other end of the upper loading rod 106, and connect the other end of the tension sensor 21 to the lower loading rod 105.

Step 5: As shown in FIG. 5-\textcircled{5}, adhere the spoke sensor pad 103 to the end of the steel tube 41 and the concrete inside the steel tube 42, and fit the spoke sensor nesting plate 104 onto the lower loading rod 105.

Step 6: As shown in FIG. 5-\textcircled{6}, install the middle disk springs 111 and middle nuts 108 successively on the lower loading rod 105, and firmly connect the spoke sensor 22 to the spoke sensor pad 103.

Step 7: As shown in FIG. 5-\textcircled{7}, install the lower loading plate 102 to the end of the lower loading rod 105 and install the lower disk springs 110 and lower nuts 107 successively on the outer side of the lower loading plate 102. Flip the entire device so that the lower loading plate 102 is at the bottom and the upper loading plate 101 is at the top. Paste the steel tube transverse strain gauges 36 and steel tube longitudinal strain gauges 37 on the middle of the steel tube 41. Fill the gap between the spoke sensor pad 103 and the spoke sensor nesting plate 104 with foam adhesive 50.

Step 8: As shown in FIG. 5-\textcircled{7}, adjust the four middle nuts 108 and lower nuts 107 to ensure that the spoke sensor nesting plate 104 and the lower loading plate 102 are level, ensuring that the bottom surface of the spoke sensor 22 and the spoke sensor pad 103 are also level, and make the CFST and the RC in the same plane. Constant axial load is applied by sequentially tightening the four upper nuts 109 in a diagonal manner until the load values of the four tension sensors 21 are the same and the load value of the spoke sensor 22 reaches the design load. During long-term loading, measure the internal forces of the CFST using the spoke sensor 22. If the internal forces decrease due to concrete creep, tighten the four upper nuts 109 in time to supplement the load.

Step 9: As shown in FIG. 5-\textcircled{8}, fix the ends of the longitudinal bars 44 to the upper loading plate 101 and the spoke sensor nesting plate 104 in the direction of the steel tube 41, and bond the stirrups 45 around the longitudinal bars 44.

Step 10: As shown in FIG. 5-\textcircled{9}, adhere the longitudinal strain gauges 38 and stirrup strain gauges 39 at the corresponding positions of the longitudinal bars 44 and stirrups 45 to measure the strain of the bar. Then pour the concrete outside the steel tube 43 and the casting of the CECFST structure 40 is completed. Install the displacement gauge 31 between the upper loading plate 101 and the spoke sensor nesting plate 104 using the lower support for displacement gauge 32, upper support for displacement gauge 33 and wire ropes 34, and measure the axial compression deformation of the CECFST structure 40. Thus, the test device for long-term loading and synchronous measurement of CECFST structure is formed.

Step 11: As shown in FIG. 5-\textcircled{9}, adjust the four middle nuts 108 to make the upper surface of the spoke sensor nesting plate 104 level with the lower end surface of the concrete inside the steel tube 42. Constant axial load is applied by sequentially tightening the four upper nuts 109 in a diagonal manner until the load values of the four tension sensors 21 are the same and the sum of the load values of the four tension sensors 21 reaches the design load. During the long-term loading process, if the internal forces decrease due to concrete creep, promptly tighten the four upper nuts 109 to replenish the load.

The beneficial effects of the invention are as follows: It provides a method for the production and installation of a test device that enables long-term loading and synchronized measurement of a CECFST structure. By properly arranging the loading components and measurement components, it is possible to independently apply loads to the CFST section and the entire CECFST structure, as well as independently measure the loads and deformations of the CFST and the entire structure. This allows for effective analysis of the load and deformation of the CECFST structure.

### DRAWINGS

FIG. 1 is an assembly diagram illustrating the loading components of the CECFST structure provided by the present invention.

FIG. 2 is an assembly diagram illustrating the load measurement components of the CECFST structure provided by the present invention.

FIG. 3-(a) is an assembly diagram illustrating the deformation measurement components of the CECFST structure provided by the present invention.

FIG. 3-(b) is a schematic diagram showing the deformation measurement components of the CECFST structure within the concrete outside the steel tube of the steel tube provided by the present invention.

FIG. 4 is a schematic diagram illustrating the components of the CECFST structure provided by the present invention.

FIG. 5-\textcircled{1} is a schematic diagram illustrating the welding of steel tubes in the installation process of the testing device provided in an embodiment of the present invention.

FIG. 5-\textcircled{2} is a schematic diagram illustrating the pouring of concrete inside the steel tubes in the installation process of the testing device provided in an embodiment of the present invention.

FIG. 5-\textcircled{3} is a schematic diagram illustrating the installation of the upper loading plate in the installation process of the testing device provided in an embodiment of the present invention.

FIG. 5-\textcircled{4} is a schematic diagram illustrating the installation of tension sensors in the installation process of the testing device provided in an embodiment of the present invention.

FIG. 5-\textcircled{5} is a schematic diagram illustrating the installation of the spoke sensor pad and the spoke sensor nesting plate in the installation process of the testing device provided in an embodiment of the present invention.

FIG. 5-\textcircled{6} is a schematic diagram illustrating the installation of the wheel-spoke sensor in the installation process of the testing device provided in an embodiment of the present invention.

FIG. 5-\textcircled{7} is a schematic diagram illustrating the installation of the lower loading plate and the loading of the CFST section in the installation process of the testing device provided in an embodiment of the present invention.

FIG. 5-\textcircled{8} is a schematic diagram illustrating the installation of the steel reinforcement skeleton in the installation process of the testing device provided in an embodiment of the present invention.

FIG. 5-\textcircled{9} is a schematic diagram illustrating the pouring of the concrete outside the steel tube and the overall loading of the CECFST structure in the installation process of the testing device provided in an embodiment of the present invention.

FIG. 6-(a) is a data plot illustrating the strain development obtained through the testing device provided by the present invention in an embodiment.

FIG. 6-(b) is a data plot illustrating the internal force development obtained through the testing device provided by the present invention in an embodiment.

Where: 10 Loading component; 101 Upper loading plate; 102 Lower loading plate; 103 Spoke sensor pad; 104 Spoke sensor nesting plate; 105 Lower loading rod; 106 Upper loading rod; 107 Lower nut; 108 Middle nut; 109 Upper nut; 110 Lower disc spring; 111 Middle disc spring; 112 Upper disc spring; 20 Load measurement component; 21 Tension sensor; 22 Spoke sensor; 30 Deformation measurement component; 31 Displacement gauge; 32 Lower support of displacement gauge; 33 Upper support for displacement gauge; 34 Wire ropes; 35 Concrete longitudinal strain gauge; 36 Steel tube transverse strain gauge; 37 Steel tube longitudinal strain gauge; 38 Longitudinal bar strain gauge; 39 Stirrup strain gauge; 40 CECFST structure; 41 Steel tube; 42 Concrete inside the steel tube; 43 Concrete outside the steel tube; 44 Longitudinal bar; 45 Stirrup 50—Foam adhesive.

### DETAILED DESCRIPTION

In conjunction with the accompanying drawings in the embodiments of the present invention, further explanation of the technical solution in the embodiments of the present invention is provided. Taking a large-span arch bridge with a CECFST structure as an example, in order to study the influence of construction loads on the structural mechanical performance, it is necessary to conduct phased long-term load tests on the components of the CECFST structure using the device provided by the present invention. The following example will illustrate this.

### (1) Example Description

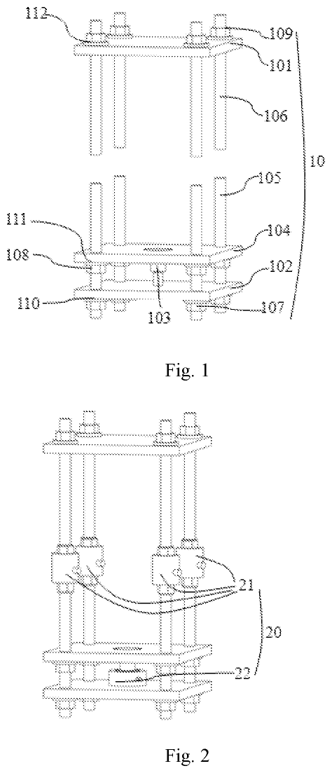

As shown in FIG. 1, the loading component 10 is disassembled into several sub-loading plate components, sub-loading rod components, sub-loading nut components, and sub-preload disc spring components, which can be processed and transported separately, thereby improving work efficiency. The design and assembly of the loading component 10 are based on the geometry and load-bearing capacity of the CECFST structure 40. In this embodiment, as shown in FIG. 4, the steel tube of the CECFST structure 40 is a circular steel tube with a diameter of 89 mm and a thickness of 4.5 mm. The concrete outside the steel tube is square with a side length of 222 mm. The component has a uniform cross-section in the length direction, with a length of 666 mm. The component is equipped with 12 longitudinal bars 44 with a diameter of 8 mm, and 14 stirrups 45 with a diameter of 6 mm are evenly arranged along the longitudinal bars 44. The concrete cover thickness of the component is 10 mm. The load-bearing capacity of the component is calculated based on the strength of the concrete inside the steel tube 42 and the concrete outside the steel tube 43, and it is determined to be 2241 kN. In this example, two stages of long-term loads are applied to the CECFST structure component, with load ratios of 0.15 and 0.2, respectively.

### (2) Design and Manufacture of Test Equipment

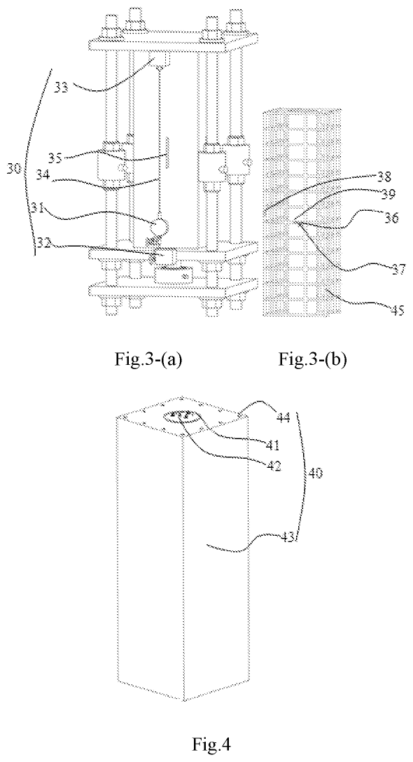

According to the design of the experimental apparatus for long-term loading and synchronous measurement of the CECFST structure component, as shown in FIG. 1, the upper loading plate 101, lower loading plate 102, and spoke sensor nesting plate 104 are all square with a side length of 465 mm. Each of the four corners of the square, close to the edge by 60 mm, has a circular hole with a diameter of 38 mm. The spoke sensor pad 103 corresponds to the CFST component and has a diameter of 89 mm. The central hole diameter of the spoke sensor nesting plate 104 is 91 mm. The distance between the inner wall of the central hole of the spoke sensor nesting plate 104 and the outer wall of the spoke sensor pad 103 is 0-2 mm. The lower loading rod 105 and upper loading rod 106 are threaded rods with a diameter of 36 mm. The distance between the holes at the four corners of the loading plate components and the inner edge of the holes is 0-2 mm. Nuts and disc springs matching the loading rods are used. The thickness of the upper loading plate 101, lower loading plate 102, spoke sensor pad 103, and spoke sensor nesting plate 104 is 30 mm. The gap between the spoke sensor nesting plate 104 and the spoke sensor pad 103 is filled with foam adhesive 50 before pouring the concrete outside the steel tube 43. As shown in FIG. 3, the concrete outside the steel tube 43 is reinforced with 12 longitudinal bars 44 with a diameter of 8 mm and 14 stirrups 45 with a diameter of 6 mm. The longitudinal bars 44 are welded to the loading plate components, and the stirrups 45 are tied to the periphery of the longitudinal bars 44 using wire. Following the fabrication steps of the experimental apparatus for long-term loading and synchronous measurement of the CECFST structure, the experimental apparatus is produced.

### (3) The CECFST Structure is Made in the Invented Test Device

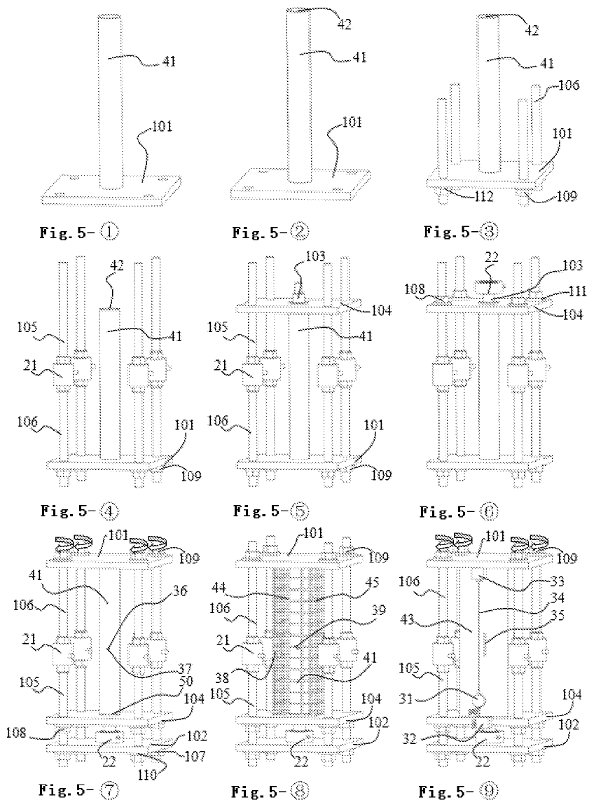

As shown in FIG. 5, the steel tube 41 is welded to the upper loading plate 101. The other end of the steel tube 41 is open and upwards, pouring concrete inside the steel tube 42, forming a CFST module. After curing, the CFST specimen is loaded using the loading component 10. After a period of time, the lower loading plate 102, spoke sensor pad 103, and spoke sensor nesting plate 104 are installed in their respective positions using nuts and screws. The foam adhesive 50 is filled between the spoke sensor pad 103 and the spoke sensor nesting plate 104 to form the upper and lower formwork modules for the concrete outside the steel tube 43. The longitudinal bars 44 are connected between the upper loading plate 101 and the spoke sensor nesting plate 104, and stirrups 45 are tied around the longitudinal bars 44 to form the steel reinforcement framework for the concrete outside the steel tube 43. The customized side formwork for the concrete outside the steel tube 43 is welded between the upper loading plate 101 and the spoke sensor nesting plate 104. The entire loading apparatus is placed horizontally, and the opening of the steel formwork for the concrete outside the steel tube 43 is facing upwards. The concrete outside the steel tube 43 is poured, forming the CECFST structure 40.

The above-described method for fabricating the CECFST structure 40 in the present invention aims to solve the challenge in scientific research of being unable to achieve on-site long-term pouring of the CECFST structure 40, which involves first pouring the concrete inside the steel tube 42, followed by the staged pouring process of the concrete outside the steel tube 43 while the concrete inside the steel tube 42 bears the load. This approach allows scientific research to better align with actual engineering practices and ensures that the research results are more realistic and accurate.

### (4) Based on the Test Device of the Invention, the CECFST Structure is Loaded in Stages

Loading the CECFST structure 40 in stages: the CFST structure is installed into the test device for long-term loading and measurement synchronization of the CECFST structure provided by the invention; Paste steel tube transverse strain gauge 36 and steel tube longitudinal strain gauge 37 to the surface of the middle position of steel tube 41; Adjust the four middle nuts 108 to the same level to ensure that the spoke sensor nesting plate 104 is level; Install the displacement gauge 31 between the upper loading plate 101 and the spoke sensor nesting plate 104 through the lower support of displacement gauge 32, upper support for displacement gaugea 33 and wire ropes 34; The four lower nuts 107 are adjusted to the same level to ensure the level of the lower loading plate 102, so as to ensure the level of the bottom surface of the spoke sensor 22 and the level of the spoke sensor plate 103, and then ensure the axial load of the CFST structure; The load of tension sensor 21 and spoke sensor 22 is cleared without load applied. As shown in FIG. 5-7), the four upper nuts 109 are loaded by tightening them diagonally in turn to ensure that the four tension sensors 21 are subjected to the same load. When the load value of the spoke sensor 22 reaches the design load, the loading is stopped, and the process of applying the load on the CFST part is completed.

Level the four middle nuts 108 and adjust the height of the spoke sensor nesting plate 104 to align its upper surface with the lower end surface of the concrete inside the steel tube 42. Weld the longitudinal bars 44 between the upper loading plate 101 and the spoke sensor nesting plate 104, and tie the stirrups 45 around the longitudinal bars 44 to form the reinforcement cage of the concrete outside the steel tube 43. Fix the template for the concrete outside the steel tube 43 at the designed position outside the reinforcement cage. Pour the concrete outside the steel tube 43 and allow it to cure. According to FIG. 5-\textcircled{9}, sequentially tighten the four upper nuts 109 diagonally to apply the load, ensuring that the load received by the four tension sensors 21 is the same. When the sum of the load values on the four tension sensors 21 reaches the design load, the loading is stopped, and the process of applying the load on the CECFST structure 40 is completed.

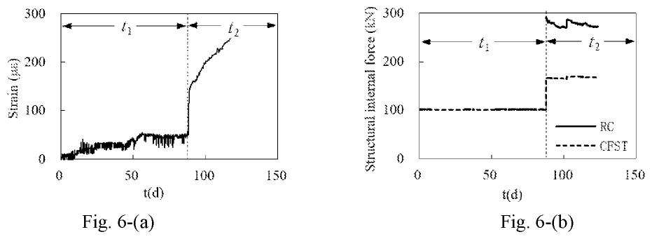

Under the two-stage long-term loading, the measured results of creep and load on the components using the experimental device in this example are shown in the FIG. 6-(a) and FIG. 6-(b), where, t₁ represents the first stage of applying long-term load solely to the CFST section, and t₂ represents the second stage of pouring the concrete outside the steel tube 43 and applying long-term load to the entire CECFST structure 40. The test results demonstrate that the present invention's device can collect the creep deformation of the structure throughout the entire loading process and can synchronously and independently measure the internal forces of the CFST section and the RC section.

The staged loading method for the CECFST structure 40, as described above, addresses the scientific challenge of accurately distinguishing the internal forces between the embedded CFST section and the surrounding RC section. It provides reliable experimental results for further studying the redistribution of internal forces and the development of deformation in such structures under long-term loading.

1. A long-term loading and synchronous measurement test apparatus for concrete-encased concrete-filled steel tube structures, characterized by comprising a loading component (10), a load measurement component (20), a deformation measurement component (30), and the concrete-encased concrete-filled steel tube structure (40);
the loading component (10) comprises an upper loading plate (101), a lower loading plate (102), a spoke sensor pad (103), a spoke sensor nesting plate 104 (104), a lower loading rod (105), an upper loading rod (106), lower nuts (107), middle nuts (108), upper nuts (109), lower disc springs (110), middle disc springs (111), and upper disc springs (112); the upper loading rod (106) passes through the upper loading plate (101), and its end is fixed on the upper loading plate (101) by the upper nuts (109) and upper disc springs (112); the lower loading rod (105) passes through the spoke sensor nesting plate (104) and the lower loading plate (102), and its end is fixed on the lower loading plate (102) by the lower nut (107) and the lower disc spring (110), and its lower portion is fixed on the spoke sensor nesting plate (104) by the middle nut (108) and the middle disc spring (111); the spoke sensor nesting plate (104) has a central hole, and one end of the spoke sensor pad (103) extends into the central hole of the spoke sensor nesting plate (104); there is a certain gap between the inner wall of the central hole of the spoke sensor nesting plate (104) and the outer wall of the spoke sensor pad (103), and the end of the spoke sensor nesting plate (104) is in the same plane as the surface of the spoke sensor pad (103), the other end of the spoke sensor pad (103) is located on the lower loading plate (102);
at least four upper loading rods (106), four lower loading rods (105), four upper nuts (109), four lower nuts (107), four upper disc springs (112), and four lower disc springs (110), together with the upper loading plate (101), the spoke sensor pad (103), and the lower loading plate (102), form the loading structure for the internal concrete-filled steel tube of the concrete-encased concrete-filled steel tube structure (40); at least four upper loading rods (106), four lower loading rods (105), four upper nuts (109), four middle nuts (108), four upper disc springs (112), and four middle disc springs (111), together with the upper loading plate (101) and the spoke sensor nesting plate (104), form the loading structure for the outer reinforced concrete of the concrete-encased concrete-filled steel tube structure (40); among them, the upper loading rod (106), the lower loading rod (105), the upper nut (109), the upper disc spring (112), and the upper loading plate (101) are common parts shared by the loading structure of the internal concrete-filled steel tube of the concrete-encased concrete-filled steel tube structure (40);
the load measurement component (20) includes tension sensors (21) and a spoke sensor (22); the tension sensor (21) is connected to the lower loading rod (105) and the upper loading rod (106) at both ends and is used to measure the load of the concrete-encased concrete-filled steel tube structure (40); the spoke sensor (22) is installed on the spoke sensor pad (103) and is used to measure the load of the concrete-filled steel tube;
the deformation measurement component (30) includes displacement gauges (31), lower supports for displacement gauges (32), upper supports for displacement gauges (33), wire ropes (34), and multiple strain gauges; at least two displacement gauges (31) and five strain gauges are combined to form the deformation measurement system of the concrete-encased concrete-filled steel tube structure (40); the displacement gauges (31) are connected between the upper loading plate (101) and the spoke sensor nesting plate (104) through the upper supports for displacement gauges (33) and the lower supports for displacement gauges (32); the strain gauges are bonded to the internal and surface of the concrete-encased concrete-filled steel tube structure (40);
the concrete-encased concrete-filled steel tube structure (40) consists of a steel tube (41), concrete inside the steel tube (42), concrete outside the steel tube (43), longitudinal bars (44), and stirrups (45); it serves as the loading and measurement object of the experimental device and is geometrically aligned within the structural framework of the loading component (10); the steel tube (41) and concrete inside the steel tube (42) form the concrete-filled steel tube, while the concrete outside the steel tube (43), longitudinal bars (44), and stirrups (45) form the outer reinforced concrete.

2. The test device for long-term loading and synchronous measurement of the concrete-encased concrete-filled steel tube structure according to claim 1, wherein the cross-section of the spoke sensor pad (103) is the same shape and has an equal area as the cross-section of the concrete-filled steel tube.

3. The test device for long-term loading and synchronous measurement of the concrete-encased concrete-filled steel tube structure according to claim 1, wherein the spoke sensor pad (103) is equipped with threaded columns and is connected to the threaded hole of the spoke sensor (22) in the load measurement component (20).

4. The test device for long-term loading and synchronous measurement of the concrete-encased concrete-filled steel tube structure according to claim 1, wherein the height of the spoke sensor pad (103) is adjusted by lower nuts (107) and the lower loading plate (102) to ensure that the spoke sensor nesting plate (104) and the spoke sensor pad (103) remain in the same plane throughout the entire loading process.

5. The test device for long-term loading and synchronous measurement of the concrete-encased concrete-filled steel tube structure according to claim 1, wherein the shape of the cross-section of the steel tube (41) and the concrete outside the steel tube (43) are not limited during the pouring of the concrete-encased concrete-filled steel tube structure (40).

6. The test device for long-term loading and synchronous measurement of the concrete-encased concrete-filled steel tube structure according to claim 1, wherein the strain gauges include concrete longitudinal strain gauges (35), steel tube transverse strain gauges (36), steel tube longitudinal strain gauges (37), longitudinal bar strain gauges (38), and stirrup strain gauges (39).

7. The installation method for a test device that enables long-term loading and synchronous measurement of a concrete-encased concrete-filled steel tube structure is described; The specific steps are as follows:
step 1: Weld the steel tube (41) at the geometric center position of the upper loading plate (101);
step 2: Pour the concrete inside the steel tube (42) from the other end of the steel tube (41);
step 3: Install four sets of upper disk springs (112), upper nuts (109), and upper loading rods (106) successively at the corresponding holes of the four corners of the upper loading plate (101);
step 4: Connect one end of the tension sensor (21) to the other end of the upper loading rod (106), and connect the other end of the tension sensor (21) to the lower loading rod (105);
step 5: Adhere the spoke sensor pad (103) to the end of the steel tube (41) and the concrete inside the steel tube (42), and fit the spoke sensor nesting plate (104) onto the lower loading rod (105);
step 6: install the middle disk springs (111) and middle nuts (108) successively on the lower loading rod (105), and firmly connect the spoke sensor (22) to the spoke sensor pad (103);
step 7: Install the lower loading plate (102) to the end of the lower loading rod (105) and install the lower disk springs (110) and lower nuts (107) successively on the outer side of the lower loading plate (102); Flip the entire device so that the lower loading plate (102) is at the bottom and the upper loading plate (101) is at the top, adhere the steel tube transverse strain gauges (36) and steel tube longitudinal strain gauges (37) to the middle of the steel tube (41), and fill the gap between the spoke sensor pad (103) and the spoke sensor nesting plate (104) with foam adhesive (50);
step 8: Adjust the four middle nuts (108) and lower nuts (107) to ensure that the spoke sensor nesting plate (104) and the lower loading plate (102) are level, ensuring that the bottom surface of the spoke sensor (22) and the spoke sensor pad (103) are level, and make the concrete-filled steel tube and the outer reinforced concrete in the same plane, constant axial load is applied by sequentially tightening the four upper nuts (109) in a diagonal manner until the load values of the four tension sensors (21) are the same and the load value of the spoke sensor (22) reaches the design load;
during long-term loading, measure the internal forces of the concrete-filled steel tube using the spoke sensor (22) and if the internal forces decrease due to concrete creep, tighten the four upper nuts (109) in time to supplement the load;
step 9: Fix the ends of the longitudinal bars (44) to the upper loading plate (101) and the spoke sensor nesting plate (104) in the direction of the steel tube (41), and bond the stirrups (45) around the longitudinal bars (44);
step 10: Adhere the longitudinal bar strain gauges (38) and stirrup strain gauges (39) at the corresponding positions of the longitudinal bar (44) and stirrups (45) to measure the strain of the bar, pour the concrete outside the steel tube (43) and the casting of the concrete-encased concrete-filled steel tube structure (40) is completed;
install the displacement gauge (31) between the upper loading plate (101) and the spoke sensor nesting plate (104) using the lower support for displacement gauge (32), upper support for displacement gauge (33) and wire ropes (34), and measure the axial compression deformation of the concrete-encased concrete-filled steel tube structure (40) and the test device for long-term loading and synchronous measurement of concrete-encased concrete-filled steel tube structure is formed;
step 11: Adjust the four middle nuts (108) to make the upper surface of the spoke sensor nesting plate (104) level with the lower end surface of the concrete inside the steel tube (42); constant axial load is applied by sequentially tightening the four upper nuts (109) in a diagonal manner until the load values of the four tension sensors (21) are the same and the sum of the load values of the four tension sensors (21) reaches the design load; during the long-term loading process, if the internal forces decrease due to concrete creep, promptly tighten the four upper nuts (109) to replenish the load.
